(19) United States
(12) Patent Application Publication
(10) Pub. No.: US 2021/0147082 A1
(43) Pub. Date: May 20, 2021

(54) OVERHEAD STOWAGE BIN ASSEMBLY

(71) Applicant: MORAN AEROSPACE, INC., Rancho Cucamonga, CA (US)

(72) Inventors: Stephen Michael KING, Irvine, CA (US); Gary Tien LE, Mt. Baldy, CA (US); Aram Aris KRIKORIAN, Ladera Ranch, CA (US); Joseph Wesley MORAN, Laguna Hills, CA (US); Louis Edward MAMMOLITO, Rancho Cucamonga, CA (US)

(21) Appl. No.: 17/097,481

(22) Filed: Nov. 13, 2020

Related U.S. Application Data
(60) Provisional application No. 62/935,871, filed on Nov. 15, 2019.

(51) Int. Cl. B64D 11/00; A47B 46/00

(52) U.S. Cl. CPC B64D 11/003; A47B 46/00

(57) ABSTRACT

An overhead stowage bin assembly having a bin structure with a lower panel and an open side that defines a front of the stowage bin assembly. The lower panel has a leading edge that is arranged at the front of the stowage bin assembly. A cover is formed by base plates and a central plate and is secured to the lower panel to form a passage. The central plate has protruding ribs that are aligned to increase the stiffness of the cover and the rigidity of the lower panel. A threshold has walls that are connected to each other and define a channel. The leading edge of the lower panel is received within the channel such that the threshold walls mate with opposite surfaces of the lower panel so as to grip the leading edge of the panel and further enhance the stiffness of the lower panel.

### PRIORITY

This application claims the benefit of U.S. Provisional Patent Application No. 62/935,871, filed on Nov. 15, 2019, which is herein incorporated by reference in its entirety.

### FIELD OF THE INVENTION

The present invention generally relates to an aircraft stowage bin assembly and, more particularly, to an overhead stowage bin assembly for use in commercial aircraft passenger cabins.

### BACKGROUND OF THE INVENTION

Aircraft passenger cabins typically have some form of overhead stowage bin assemblies that enable passengers to stow their carry-on luggage during a flight. There are a number of different types of known stowage bin assemblies in the art. Many of these stowage bin assemblies are constructed with a number of panels that are arranged in the form of a container having an open side. Such known stowage bin assemblies are typically mounted to the wall and/or ceiling of the passenger cabin such that they can be pivoted or moved between open and closed positions. In the open position, luggage can be loaded into the interior of the stowage bin assembly and supported on base panel that is generally horizontally arranged or slightly inclined toward the back so as to retain luggage within the interior of the stowage bin assembly. From the open position, the stowage bin assembly is pivoted or lifted to the closed position in which the front side of the base panel is higher than the rear and the bin opening faces a more upward direction and is typically enclosed by a fixed panel. Stowage bin assemblies have one or more latching mechanisms that function to secure the stowage bin assembly in the closed position. Release latches are typically located on an exterior side of the base panel and can be actuated to disengage the latching mechanisms thereby releasing the stowage bin assembly and enabling it to pivot or lower to the open position.

Although these known stowage bin assemblies are acceptable for their intended purpose, as passenger use of these stowage bin assemblies and the weight of carry-on luggage has increased over time, some of the drawbacks of known stowage bins have become apparent. For example, as loads on the relatively thin lightweight base panel increase due to the heavy weights of the carry-on luggage the base panel has the tendency of flexing or bowing under such loads. This flexing or bowing can be exacerbated by additional loads placed on the lower panel when passengers pull down on the lower wall to open the stowage bin assembly.

Over time certain components, such as a torque tube protective cover and threshold, or their connections to the base panel, can be weakened by deflection of the base wall and by repeated impacts with luggage as luggage is tossed into and pulled from the stowage bin assembly. When luggage is removed from stowage bin assemblies, it has the tendency to catch on the threshold and generate an overturning (torsional) load on the threshold and base panel. In combination, the repeated deflection of the base panel, impacts and catching of the luggage on the torque tube protective cover and threshold can lead to damage of the torque tube protective cover and threshold and, in some cases, the threshold cover can completely break off.

### SUMMARY OF THE INVENTION

Wherefore, it is an object of the present invention to overcome the above mentioned shortcomings and drawbacks associated with the prior art.

Another object of the present invention is to provide a rigid torque tube cover stowage bin that can be connected to a lower panel of an overhead stowage bin assembly to enhance the stiffness of the lower panel and the rigidity of the stowage bin assembly.

A further object of the present invention is to provide a rigid threshold having a channel that grips the leading edge of the lower panel and further enhances the stiffness of the lower panel and rigidity of the stowage bin assembly.

A still further object of the present invention is to provide the torque tube cover with ribs that extend from the torque tube cover and increase rigidity of the torque tube cover and additionally stiffen the lower panel when connected to the stowage bin assembly.

Yet another object of the present invention is to form a threshold with a geometry which increases the torsional rigidity of the threshold and can be secured to torque tube cover and the lower panel to further increase the stiffness of the lower panel and rigidity of the stowage bin assembly.

The present invention also relates to an overhead stowage bin assembly for aircraft. The stowage bin assembly having a lower panel that is configured to support objects within an interior of the stowage bin assembly. The lower panel has interior and exterior surfaces and a leading edge. The leading edge partially defines an opening of the stowage bin assembly which provides access to the interior thereof. An elongate covering has base plates and a raised central segment that extends between the base plates. The base plates are connected to the interior surface of the lower panel such that an inner passage is formed between the lower panel and the covering. A plurality of ribs protrude from the central segment and are aligned in a direction from the opening of the stowage bin assembly to a rear of the stowage bin assembly. The plurality of ribs are configured to increase a stiffness of the covering, and the covering is connected to the lower panel to increase a rigidity of the lower panel. A threshold has first and second threshold walls that define a channel therebetween. The threshold is connected to the lower panel such that the leading edge of the lower panel is received within the channel and gripped between the first and the second threshold walls to further increase the rigidity of the lower panel.

### BRIEF DESCRIPTION OF THE DRAWINGS

The accompanying drawings, which are incorporated in and constitute a part of the specification, illustrate various embodiments of the invention and together with the general description of the invention given above and the detailed description of the drawings given below, serve to explain the principles of the invention. The invention will now be described, by way of example, with reference to the accompanying drawings in which:

FIG. 1 is a pictorial view of an overhead stowage bin assembly according to the invention;

FIG. 2 is a front plan view of the overhead stowage bin assembly according to the invention as illustrated in FIG. 1;

FIG. 3 is a top plan view of the overhead stowage bin assembly according to the invention as illustrated in FIG. 1;

FIG. 4 is a cross-sectional view of the overhead stowage bin assembly according to the invention as illustrated in FIG. 1;

FIG. 5 is a cross-sectional view of the overhead stowage bin assembly illustrated in FIG. 4 showing a leading side of a lower panel in greater detail;

FIG. 6 is a top plan view of a portion of the overhead stowage bin assembly illustrated in FIG. 3 showing of the leading side of a lower panel in greater detail;

FIG. 7 is a cross-sectional plan view of the leading side of the lower panel;

FIG. 8 is a cross-sectional plan view showing a close up of the leading side of the lower panel illustrated in FIG. 7;

FIG. 9 is a cross-sectional pictorial view of the leading side of the lower panel illustrated in FIG. 8; and

FIG. 10 is a pictorial view showing the right an end of the leading side of the lower panel of the overhead stowage bin assembly.

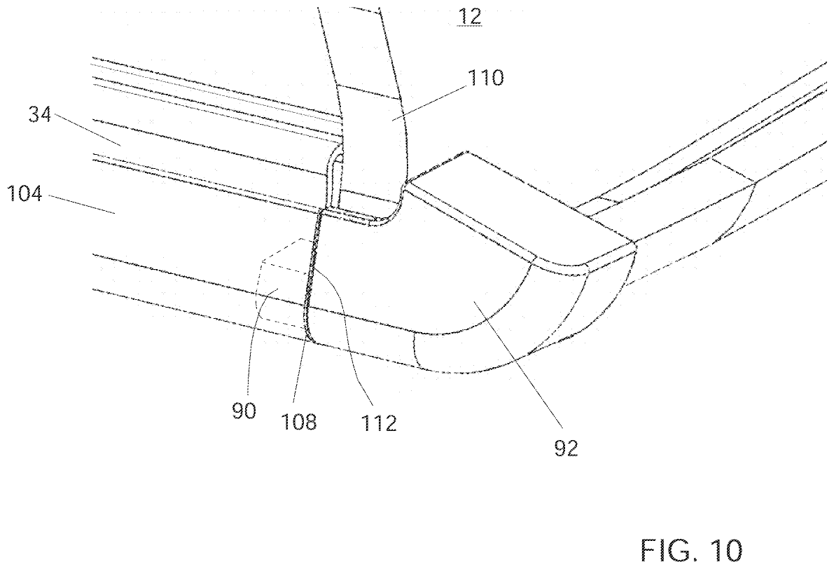

It should be understood that the drawings are not necessarily to scale and that the disclosed embodiments are sometimes illustrated diagrammatical and in partial views. In certain instances, details which are not necessary for an understanding of this disclosure or which render other details difficult to perceive may have been omitted. It should be understood, of course, that this disclosure is not limited to the particular embodiments illustrated herein.

### DETAILED DESCRIPTION OF THE PREFERRED EMBODIMENTS

The present invention will be understood by reference to the following detailed description, which should be read in conjunction with the appended drawings. It is to be appreciated that the following detailed description of various embodiments is by way of example only and is not meant to limit, in any way, the scope of the present invention.

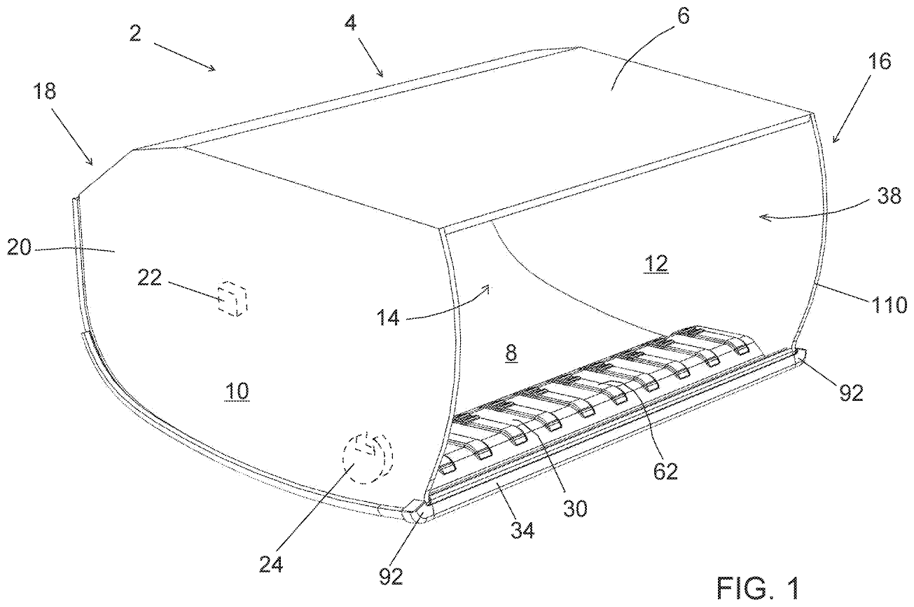

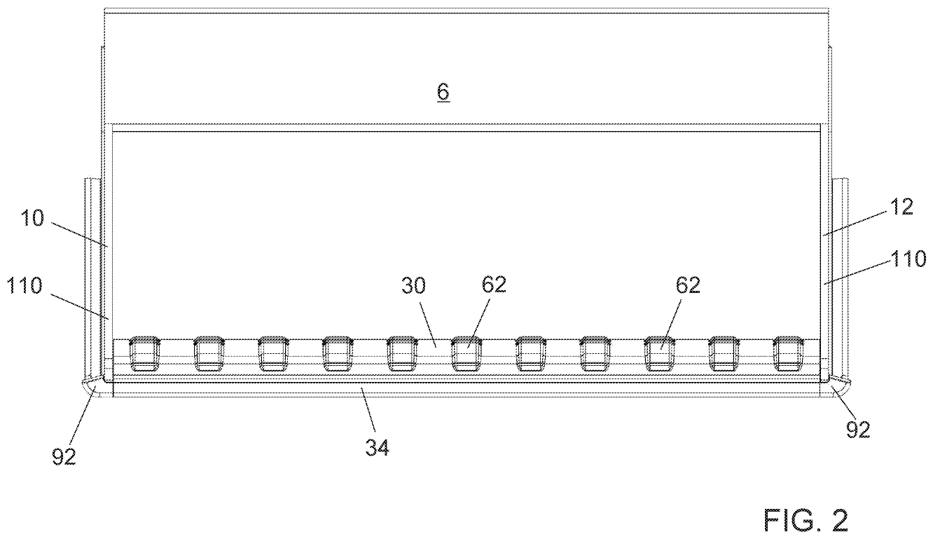

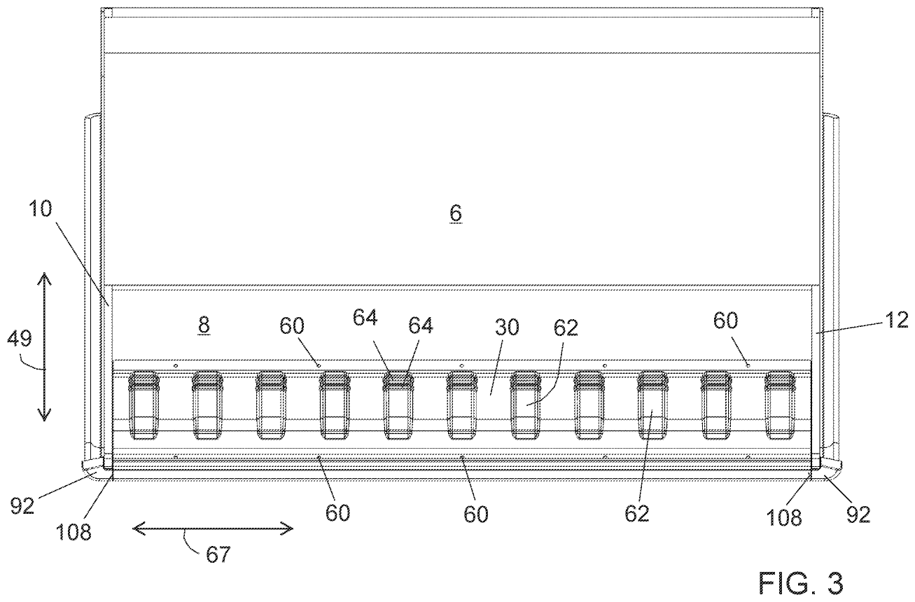

Turning now to FIG. 1, a brief description concerning the various components of the present invention will now be briefly discussed. As can be seen in this embodiment, the present invention relates to an overhead stowage bin assembly 2 having a bin structure 4 that is formed by a number of panels including upper and lower panels 6, 8 and two side panels 10, 12. These panels 6, 8, 10, 12 can define an opening 14 at the front 16 of the stowage bin assembly 2. As such bin structures are generally known in the art, further description of the same is not believed to be required. Suffice it to say that the panels 6, 8, 10, 12 can have a variety of shapes and sizes such that the bin structure 4 can assume different forms, but generally the bin structure 4 is approximately a rectangular prism or cuboid. That is to say, the width of the bin structure 4 (measurement in a side to side direction 67) from one side panel 10 to the other side panel 12 is commonly greater than its depth (measurement in front to back direction 49) from the front 16 to a back 18 of the stowage bin assembly 2, and its height from the lower panel 8 to the upper panel 6 as can be seen in FIGS. 2 and 3.

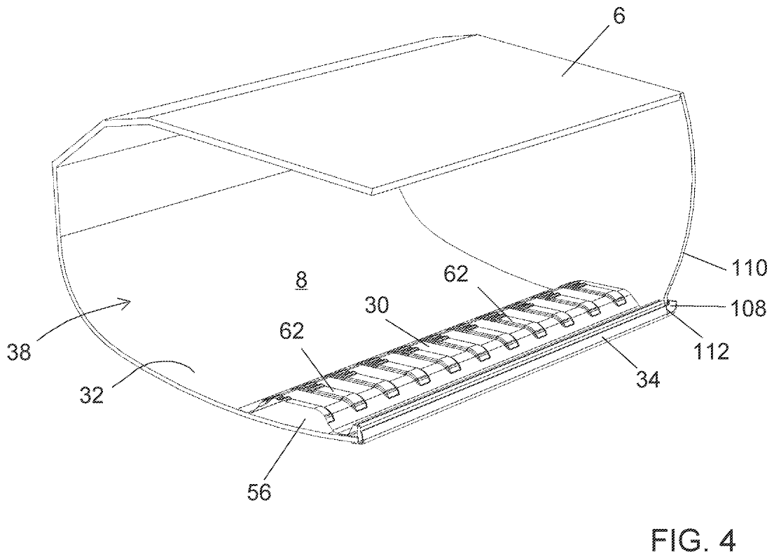

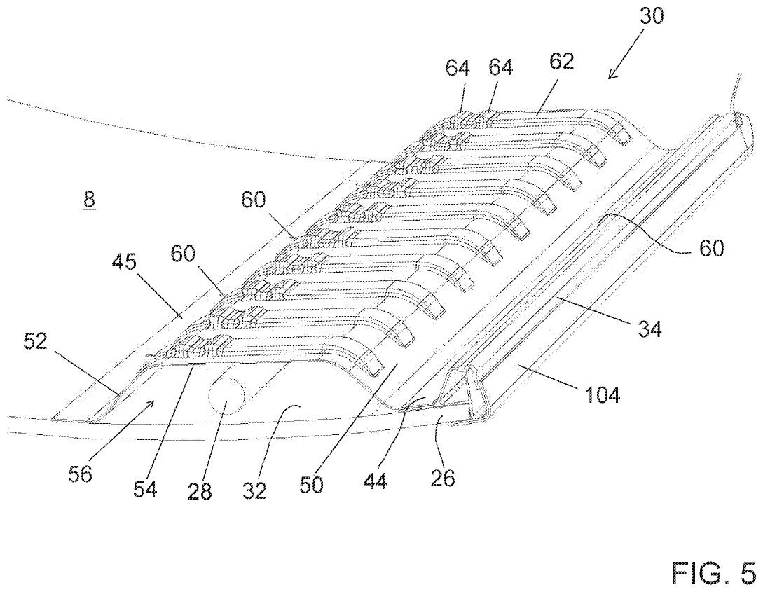

The stowage bin assembly 2 is typically mounted in aircraft passenger cabins above the passenger seats by way of a support structure such that the opening 14 of the stowage bin assembly 2 generally faces the aisle to facilitate loading and unloading of carry-on luggage into and out of the stowage bin assembly 2. As diagrammatically shown in FIG. 1, a number of known components (shown in dashed lines) can be mounted on the exterior surfaces 20 of the side panels 10, 12. These components can be utilized for controlling movement of the stowage bin assembly 2 as well as securing/releasing the stowage bin assembly 2 in/from an upper closed position. As these components are generally known, they will not be discussed in detail. Typically, a coupling 22 can be secured to the side panels 10, 12 which connect a rate controlling unit (not shown) to the bin structure 4. Rate controlling units basically function as a safety feature which reduces how fast the stowage bin assembly 2 pivots or drops to a lower open position when released from the closed position. A latching mechanism 24 can also be mounted on the exterior surface 20 of the side panels 10, 12. As is known in the art, such latching mechanisms 24 engage with corresponding latching studs (not shown) that are fixed to the support structure so as to secure the stowage bin assembly 2 in the closed position. Commonly, latches (not shown) communicate by way of torque tubes 28 (see FIGS. 4 and 5) with the latching mechanisms 24, and can be actuated to disengage the latching mechanisms 24 from the latching studs, thereby releasing the stowage bin assembly 2 from the closed position.

As generally shown in the figures, the stowage bin assembly 2 according to the invention includes a torque tube cover or covering 30 that is mounted to an interior (top) surface 32 of the lower panel 8 which covers and protects the torque tubes 28 and associated connection with the latch from contact with luggage. The stowage bin assembly 2 further includes a threshold 34 that is mounted to a leading edge 26 (front portion) of the lower panel 8. The torque tube cover 30 and threshold 34 are formed to have geometries that are particularly rigid and resistant to bending and torsional forces such that when mounted to the lower panel 8, the torque tube cover 30 and threshold 34 significantly increase the rigidity of the lower panel 8 and the structural stiffness of the stowage bin assembly 2. The torque tube cover 30 and threshold 34 will be discussed in greater detail below with reference to FIGS. 5-9.

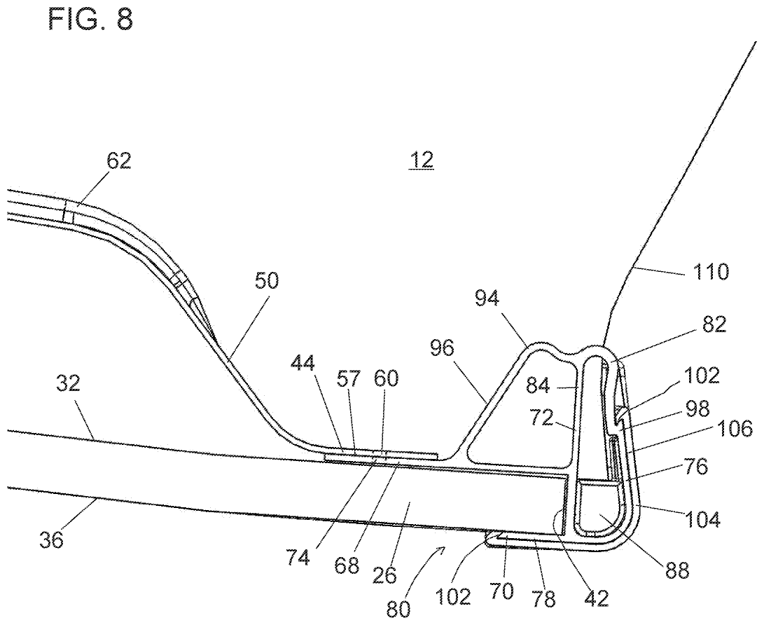

FIGS. 5, 7 and 8 show a cross-section of the front 16 of the stowage bin assembly 2. As can be seen, the lower panel 8 has the interior surface 32 and an exterior (bottom) surface 36 which face an interior 38 and exterior 40 of the stowage bin assembly 2, respectively. The lower panel 8, in this case, is formed so as to have a cross-section that is slightly curved in an outward direction or, in other words, is slightly convex in shape. When viewing the lower panel 8 from the front 16 of the stowage bin assembly 2, such as seen in FIG. 2, the lower panel 8 in an unloaded state, extends straight between the two side panels 10, 12, i.e., the lower panel 8 does not bow or curve. As best seen in FIG. 8, the leading edge 26 of the lower panel 8 has a front surface 42 that is at least substantially perpendicular to the top and bottom surfaces 32, 36 of the lower panel 8.

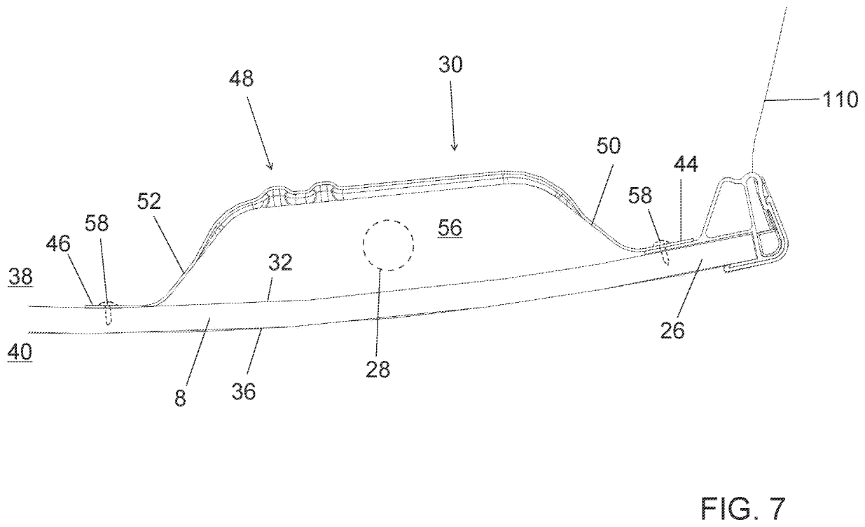

The torque tube cover 30, according to the invention, is preferably made from a sheet of a lightweight metal such as aluminum, however it should be recognized that the torque tube cover 30 can be made from plastic, polymeric or composite materials including woven or non-woven carbon fiber for example. These materials can be stamped, pressed, molded or bent such that the torque tube cover 30 is a singular, integrally formed component having a substantially uniform material thickness and a cross-sectional shape (see FIG. 7, for example) that is similar to that of an inverted bowl. As shown in FIGS. 2 and 3, the torque tube cover 30 extends laterally within the stowage bin assembly 2, meaning from one side panel 10 of the stowage bin assembly 2 to the other side panel 12. The torque tube cover 30 has front and back base plates 44, 46 and a raised central plate or segment 48 extending between the front and back base plates 44, 46. The central plate 48 is formed by front and back inclined walls 50, 52 that extend upwardly from the base plates 44, 46, and an upper wall 54 that extends between the inclined walls 50, 52 and is generally parallel to the base plates 44, 46. When mounted on the top surface 32 of the lower panel 8, the torque tube cover 30 forms an inner passage 56 in which torque tubes 28 extend between the latch and latching mechanisms 24 as previously described. It is to be appreciated that the important aspect of the inclined walls 50, 52 is to offset the upper wall 54 of the torque tube cover 30 from the top surface 32 of the lower panel 8 by a distance that prevents contact between the torque tube cover 30 and the torque tubes 28 located within the passage 56. As suggested above, the torque tube cover 30 functions to enclose and protect the torque tubes 28 from contact with luggage for example. Additionally, when mounted on the lower panel 8, the torque tube cover 30 stiffens the lower panel 8 and thereby increases the rigidity of the stowage bin assembly 2.

The front and the back base plates 44, 46 are formed to have a profile that matches the profile of the lower panel 8. That is to say in other words that the front and back base plates 44, 46 are slightly curved such that the mating surfaces 57 of the front and back base plates 44, 46 lay on the top surface 32 of the lower panel 8. Preferably, an entirety of the mating surfaces 57 lay upon the top surface 32 of the lower panel 8 such that any load placed on the torque tube cover 30 is distributed over a greater amount of the top surface 32. However, as the depth of the front and back base plates 44, 46 is relatively short in comparison to the depth (front to back measurement) of the lower panel 8, the front and back base plates 44, 46 can be planar and their profile will still at least substantially match that of the top surface 32 of the lower panel 8. In sum, regardless of whether the front and back base plates 44, 46 are slightly curved or substantially planar, the front and back base plates 44, 46 lay flat on the top surface 32 of the lower panel 8.

The torque tube cover 30 can be fixed to the lower panel 8 by fasteners 58 that pass through a number of through-holes 60 in the front and back base plates 44, 46 and engage in the lower panel 8. The fasteners 58 can be for example threaded screws or rivets. As seen in FIG. 3, these through-holes 60 are located along the width (side to side measurement) of the base plates 44, 46 between the side panels 10, 12. It should be appreciated that instead of or in addition to such fasteners 58, the torque tube cover 30 can be fixed to the lower panel 8 by means of adhesive. Securing the front and back base plates 44, 46 to the lower panel 8 reduces the ability of the torque tube cover 30 to bend, e.g., by applying a force or load on the upper wall 54 thereof in a downward direction, thereby enhancing the stiffness of the torque tube cover 30 and thus the stiffness of the lower panel 8 and rigidity of the stowage bin assembly 2.

The torque tube cover 30 has a number of protruding ribs 62 that extend across the torque tube cover 30. The ribs 62 can be stamped or pressed in the torque tube cover 30 so as to protrude from the upper wall 54 of the torque tube cover 30. The ribs 62 can extend in the front to back direction 49 from one of the inclined walls 50 across the upper wall 54 to the other one of the inclined walls 52. As best seen in FIG. 3, the ribs 62 are evenly spaced from each other along the length of the torque tube cover 30 between the side plates 10, 12 and extend essentially parallel to each other and the side panels 10, 12. The protruding ribs 62 formed in the torque tube cover 30 act to enhance the stiffness of the torque tube cover 30 and thus the stiffness of the lower panel 8 and rigidity of the stowage bin assembly 2. The torque tube cover 30 further helps to distribute loads placed thereon by luggage for example, across the width of the stowage bin assembly 2.

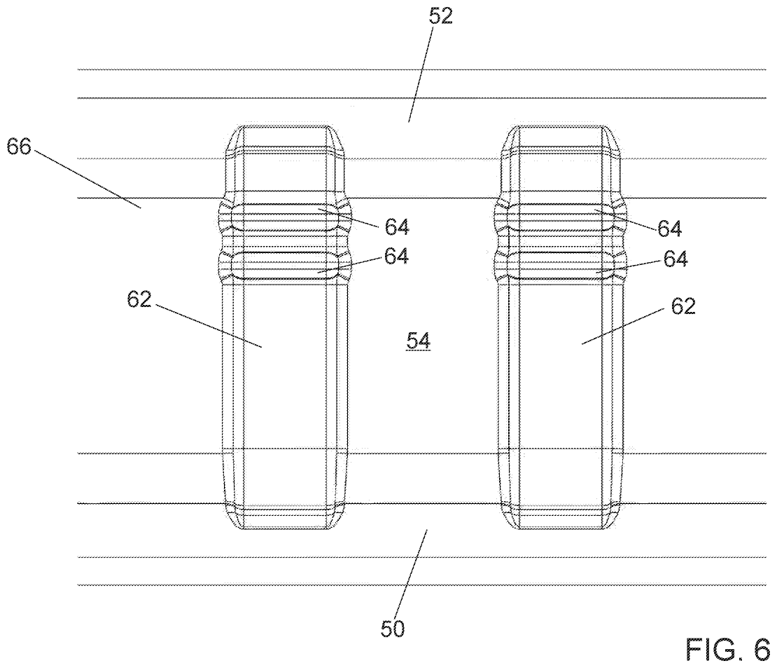

Each of the ribs 62 has a pair of ridges 64 that protrude from the rib 62 and are located on the rib 62 adjacent a rear side 66 of the upper wall 54. The ridges 64 can be stamped or pressed in the ribs 62 so as to protrude from a surface of the rib 62. As best seen in FIG. 6, the ridges 64 are aligned on the ribs 62 so as to extend in a side to side direction 67, i.e., towards the side panels 10, 12. In other words the ridges 64 extend at least substantially perpendicular relative to the front to back direction 49 in which the ribs 62 extend. When carry-on luggage is arranged within the stowage bin assembly 2 it usually rests on the ribs 62 of the torque tube cover 30. The ridges 64 protruding from the ribs 62 generally function additional points of contact, friction points or restriction elements that communicate with and curtail movement of the luggage loaded into the stowage bin assembly 2. In some instances, an edge of the luggage can abut and catch a side of one or more ridges 64 such that movement of the luggage, at least in a direction toward the front 16 or opening 14 of the stowage bin assembly 2, is restricted to some degree. In other instances, such as when the luggage lays atop the ribs 62, the ridges 64 function as points of contact between the luggage and ribs 62 and frictionally reduce movement of the luggage across the ribs 62.

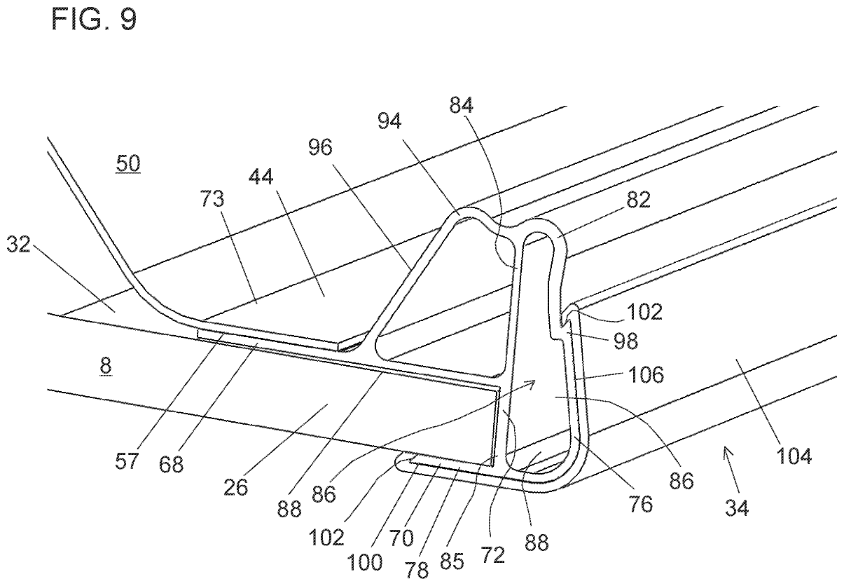

The stowage bin assembly 2 further includes a threshold 34 that extends, as shown in FIGS. 2 and 3, laterally in the side to side direction 67 from one side panel 10 of the stowage bin assembly 2 to the other side panel 12. The threshold 34 is mounted on the leading edge 26 of the lower panel 8 and has a geometry that covers the front surface and stiffens the leading edge 26 of the lower panel 8. The threshold 34 can be formed from a lightweight metal or metal alloy such as aluminum for example that can be extruded. It is also possible to form the threshold 34 from other materials such as a composite material, including a woven or non-woven carbon fiber, or a polymeric or plastic material that can be injection molded or extruded into the desired geometry. As best seen in the close-up cross-sectional views of FIGS. 8 and 9, the threshold 34 generally has four threshold walls that are interconnected and integrally formed as a unitary component. At least portions of the first, second and third threshold walls 68, 70, 72 are substantially planar and are arranged so as to overlay, mate or abut the front, top and bottom surfaces 42, 32, 36 of the lower panel 8 at the leading edge 26 thereof.

As best shown in FIG. 8, an entirety of the first threshold wall is at least substantially planar and is integrally connected and substantially perpendicular to the third threshold wall. The first threshold wall 68 extends rearward from the third threshold wall along the top surface 32 of the lower panel 8 to a point at the rear side 73 of the front base plate 44 of the torque tube cover 30. As can be seen in the figures, a portion of the first threshold wall 68 extends between the lower panel 8 and the front base plate 44 of the torque tube cover 30. As shown, the first threshold wall 68 overlays the top surface 32 of the lower panel 8 such that the surface of the first threshold wall 68 mates with or contacts the top surface 32 of the lower panel 8. Preferably, the entire panel facing surface of the first threshold wall 68 mates with or contacts the top surface 32 of the lower panel 8.

The first threshold wall 68 has a number of through-holes 74 that facilitate fixing the threshold 34 to the leading edge 26 of the lower panel 8 by means of fasteners 58. As diagrammatically shown in FIG. 8, the through-holes 74 in the first threshold wall 68 are located along its width between the side panels 10, 12. As the first threshold wall 68 extends between the front base plate 44 of the torque tube cover 30 and the lower panel 8, when properly situated on the lower panel 8, the through-holes 74 in the first threshold wall 68 align with the through holes 60 in the front base plate 44. Given this arrangement, fasteners 58 can pass through the through-holes 60, 74 in the front base plate 44 and first threshold wall 68 and can engage in the lower panel 8 such that both the front base plate 44 of the torque tube cover 30 and the threshold 34 can be fixed to each other and the lower panel 8. It should be appreciated that instead of or in addition to such fasteners 58, the threshold 34 can be fixed to the lower panel 8 and/or to the front base plate 44 by means of an adhesive. In this case, adhesive would be applied between surfaces of the first threshold wall 68 and the front base plate 44 and top surface 32 of the lower panel 8. Although the figures show the first threshold wall 68 as extending between the front base plate 44 of the torque tube cover 30 and the lower panel 8, i.e., below the front base plate 44, it is to be appreciated that the first threshold wall 68 could extend over or on top of the front base plate 44.

As best shown in FIG. 8, the second threshold wall 70 has leading and trailing portions 76, 78. The trailing portion 78 is at least substantially planar and extends rearward from the third threshold wall 72 along the bottom surface 36 of the lower panel 8. As shown, the third threshold wall 72 is integrally connected to the rearward portion 78 of the second threshold wall 70 such that the rearward portion 78 of the second threshold wall 70 extends at least substantially perpendicular to the third threshold wall 72. In this configuration, the first and second threshold walls 68, 70 are at least substantially parallel to each other. The rearward portion 78 of the second threshold wall 70 overlays and mates with or contacts the bottom surface 36 of the lower panel 8.

As best shown in FIG. 8, the third threshold wall 72 is at least substantially planar and extends upward from the second threshold wall 70 to beyond or above the first threshold wall 68 as will be described in further detail below. As shown, the third threshold wall 72 overlays the front surface 42 of the lower panel 8 such that the third threshold wall 72 mates with or contacts the front surface 42. The third threshold wall 72 has a height (top to bottom measurement) that approximately corresponds to or is slightly shorted than the overall height of the threshold 34.

In combination the first threshold wall 68, the trailing portion 78 of the second threshold wall 70 and a portion of the third threshold wall 72 form a channel 80 that extends laterally from one side panel 10 of the stowage bin assembly 2 to the other side panel 12. As shown in FIGS. 8, 9, the channel 80 has a cross-sectional profile that closely corresponds to the cross-sectional profile of the leading edge 26 of the lower panel 8. The leading edge 26 of the lower panel 8 is received within the channel 80 such that the first, second and third threshold walls 68, 70, 72 mate with and grip the leading edge 26 of the lower panel 8 with an interference-fit, press-fit, friction-fit or form-fit connection. The contact between the walls 68, 70, 72 of the threshold 34 and the surfaces 32, 36, 42 of the lower panel 8 stiffen the lower panel 8 and increases the rigidity of the stowage bin assembly 2.

As shown in FIGS. 8, 9, the leading portion 76 of the second threshold wall 70 extends forward from the trailing portion 78 and the connection with the third threshold wall 72. A lower end of the leading portion 76 is curved such that the second threshold wall 70 extends generally upward to an upper end 82 that is rounded and integrally connected to an upper edge 84 of the third threshold wall 72. Together the third threshold wall 72 and the leading portion 76 of the second threshold wall 70 form a forward chamber 86 that is generally situated on a forward side of the threshold 34. The threshold 34 is configured such that a lower portion 88 of the forward chamber 86 has a greater depth (front to back dimension) than that of an upper portion of the forward chamber 86. The forward chamber 86 of the threshold 34 has a geometry that captively receives and retains correspondingly shaped nubs 90 of end caps 92 as described in further detail below.

A fourth threshold wall 91 generally extends upward, in the view of FIG. 8, and is inclined relative to the first threshold wall 68 toward the third threshold wall 72. A lower end 93 of the fourth threshold wall 91 is integrally connected to a central point of the first threshold wall 68 and the upper end 94 of the fourth threshold wall 91 is curved and integrally connected to the upper edge 84 of the third threshold wall 72. In this configuration, the fourth threshold wall 91 is angled away from the torque tube cover 30 and the rear 18 of the stowage bin assembly 2 and forms a luggage abutment surface 96. The threshold 34 is configured such that when luggage is loaded into the interior 38 of the stowage bin assembly 2, an edge of the luggage typically contacts the fourth threshold wall 91 which limits or stops the luggage from sliding in a direction toward the opening 14 of the stowage bin assembly 2, thereby preventing luggage from unexpectedly falling from the stowage bin assembly 2.

The upper edge 84 of the third threshold wall 72 is integrally connected to the upper end 82 of the leading portion 76 of the second threshold wall 70 and the upper end 94 of the fourth threshold wall 91. As such the third threshold wall 72 functions to stiffen the threshold 34 and thus the leading edge 26 of the lower panel 8.

The outer surface of the second threshold wall 70 includes a pair retaining spines 98, 100, as seen in the cross-sectional views of FIGS. 8 and 9, that extend along the width of the threshold 34 from one side panel 10 to the other side panel 12. The first retaining spine 98 is located in an area of the upper end 82 of the second threshold wall 70 and the second retaining spine 100 is located at the end of the trailing portion 78 of the second threshold wall 70. Each of the retaining spines 98, 100 forms a catch surface that engage with correspondingly shaped catch surfaces 102, 103 arranged at opposite sides of a plastic slip-on sleeve 104. When installed on the threshold 34, the slip-on sleeve 104 covers and protects the exposed front face 106 of the extruded threshold 34. To install the slip-on sleeve 104 on the threshold 34, the slip-on sleeve 104 is positioned with respect to the threshold 34 such that one end of the slip-on sleeve 104 is directly adjacent an end 108 of the threshold 34 and the corresponding catch surfaces of the threshold 34 and the slip-on sleeve 104 are aligned with each other. The slip-on sleeve 104 is then moved to the point where the catch surfaces of the threshold 34 and the slip-on sleeve 104 engage. The slip-on sleeve 104 is then slid along the threshold 34 to an installed position in which the ends of the slip-on sleeve 104 and threshold 34 are flush.

As indicated above, the threshold 34 extends the width of the bin structure 4 such that the ends 108 of the threshold 34 come into contact with the interior surfaces of the side panels 10, 12. When mounted on the leading edge 26 of the lower panel 8, the threshold 34 protrudes forward beyond front surfaces 110 of the side panels 10, 12. As best seen in the cross-sectional view of FIG. 8, the forward chamber 86 is located further forward than the front surface 110 of the side panel 12. In this condition the ends 108 of the threshold 34 are exposed and the slip-on sleeve 104 can be simply installed and removed by sliding it along the threshold 34. In order to enhance the aesthetics of the stowage bin assembly 2 and mechanically retain the slip-on sleeve 104 in the installed position, end caps 92 can be fastened at the ends 108 of the threshold 34. To facilitate fastening of the end caps 92, the bottom corner of the side panels 10, 12 are notched so as to expose the lower portion 88 of the forward chamber 86 of the threshold 34. Each end cap 92 has a nub 90 that extends from a mating surface 112 of the end cap and is configured or rather sized and shaped so as to be received within the forward chamber 86 and engage with the corresponding surfaces that form the forward chamber 86. In this position the end caps 92 are pushed further toward the threshold 34 until the mating surface 112 of the end caps 92 abuts the ends 108 of the threshold 34. With the nubs 90 of the end caps 92 fully received within the forward chamber 86, an interference-fit is formed between the end caps 92 and the corresponding surfaces of the forward chamber 86 of the threshold 34. When installed, the end caps 92 mechanically retain the slip-on sleeve 104 in the installed position on the threshold 34. With the end caps 92 being connected to the threshold 34 by an interference-fit, they can be withdrawn from the threshold 34 such that the slip-on sleeve 104 can be simply removed and installed on the threshold 34.

While various embodiments of the present invention have been described in detail, it is apparent that various modifications and alterations of those embodiments will occur to and be readily apparent to those skilled in the art. However, it is to be expressly understood that such modifications and alterations are within the scope and spirit of the present invention, as set forth in the appended claims. Further, the invention(s) described herein is capable of other embodiments and of being practiced or of being carried out in various other related ways. In addition, it is to be understood that the phraseology and terminology used herein is for the purpose of description and should not be regarded as limiting. The use of “including,” “comprising,” or “having,” and variations thereof herein, is meant to encompass the items listed thereafter and equivalents thereof as well as additional items while only the terms “consisting of” and “consisting only of” are to be construed in a limitative sense.

The foregoing description of the embodiments of the present disclosure has been presented for the purposes of illustration and description. It is not intended to be exhaustive or to limit the present disclosure to the precise form disclosed. Many modifications and variations are possible in light of this disclosure. It is intended that the scope of the present disclosure be limited not by this detailed description, but rather by the claims appended hereto.

A number of implementations have been described. Nevertheless, it will be understood that various modifications may be made without departing from the scope of the disclosure. Although operations are depicted in the drawings in a particular order, this should not be understood as requiring that such operations be performed in the particular order shown or in sequential order, or that all illustrated operations be performed, to achieve desirable results.

Wherefore, I/We claim:

1. An overhead stowage bin assembly for aircraft, comprising:
a lower panel configured to support objects within an interior of the stowage bin assembly, the lower panel having interior and exterior surfaces and a leading edge, the leading edge partially defines an opening of the stowage bin assembly which provides access to the interior thereof;
a covering having first and second base plates and a raised central segment, the first and the second base plates being connected to the interior surface of the lower panel such that an inner passage is formed between the lower panel and the covering, a plurality of ribs protrude from the central segment and are aligned in a direction from the opening of the stowage bin assembly to a rear of the stowage bin assembly, the plurality of ribs being configured to increase a stiffness of the covering, and the covering being connected to the lower panel to increase a rigidity of the lower panel; and
a threshold having first and second threshold walls that define a channel therebetween, the threshold being connected to the lower panel such that the leading edge of the lower panel is received within the channel and gripped between the first and the second threshold walls to further increase the rigidity of the lower panel.

2. The overhead stowage bin assembly according to claim 1, wherein the first and the second threshold walls being rigidly connected to each other, the first threshold wall overlays and mates with the interior surface of the lower panel and the second threshold wall overlays and mates with the exterior surface of the lower panel to grip the leading edge of the panel therebetween.

3. The overhead stowage bin assembly according to claim 1, wherein the threshold comprises a third threshold wall having upper and lower edges, the first threshold wall being connected to the third threshold wall and extending therefrom in the direction from the opening of the stowage bin assembly to the rear of the stowage bin assembly, the second threshold wall being connected to the lower edge of the third threshold wall and extending therefrom substantially parallel to the first threshold wall, and the third threshold wall mates with a front surface of the leading edge of the lower panel.

4. The overhead stowage bin assembly according to claim 3, wherein the first threshold wall is sized such that one surface of the first threshold wall mates with the exterior surface of the lower panel and an opposite surface of the first threshold wall mates with the first base plate of the cover, and the first threshold wall, the first base plate and the lower panel are fixed to each other.

5. The overhead stowage bin assembly according to claim 1, wherein the threshold has third and fourth threshold walls and is configured such that
the first threshold wall is connected perpendicular to the third threshold wall;
a trailing portion of the second threshold wall is connected to a lower edge of the third threshold wall, the first and the second threshold walls being parallel and spaced from each other such that the first threshold wall lays on the interior surface of the lower panel and the second threshold wall lays on the exterior surface of the lower panel;
an upper edge of the third threshold wall extends beyond the first threshold wall and is connected to a leading portion of the second threshold wall; and
an edge of the fourth threshold wall is connected to the first threshold wall and an opposite edge of the fourth threshold wall is connected the upper edge of the third threshold wall.

6. The overhead stowage bin assembly according to claim 5, wherein the channel is further defined by the third threshold wall, and the second and the third threshold walls are connected and form a chamber that is located in front of the leading edge of the lower panel to protect the threshold from impact with the objects being loaded into the stowage bin assembly, the chamber forming an opening at respective ends of the threshold, each of the chambers being configured to receive and engage a nub of a respective end cap.

7. The overhead stowage bin assembly according to claim 1, wherein an outer facing surface of the second threshold wall comprises first and second splines that extend between opposite ends of the threshold, each of the first and the second splines mates with a corresponding one of first and second catch surfaces of a slip-on sleeve in an installed position of the slip-on sleeve on the outer facing surface of the second threshold wall.

8. The overhead stowage bin assembly according to claim 7, wherein the second threshold wall partially defines a chamber that is located in front of the leading edge of the lower panel, the chamber forms an opening at the respective opposite ends of the threshold which are configured to receive and engage a nub of a respective end cap, the end caps received in the opposite ends of the threshold abut corresponding ends of the slip-on sleeve and prevent withdrawal of the slip-on sleeve from the installed position.

9. The overhead stowage bin assembly according to claim 5, wherein the edge of the fourth threshold wall connected to the first threshold wall is spaced at a distance from the third threshold wall such that, from the first threshold wall to the third threshold wall, the fourth threshold wall is angled toward the opening of the stowage bin assembly, and such that the fourth threshold wall faces the interior of the stowage bin assembly and forms a luggage abutment surface.

10. The overhead stowage bin assembly according to claim 1, wherein the raised central segment comprises first and second inclined walls that are connected to the first and the second base plates, respectively, and a center wall is connected between the first and second inclined walls; and
the covering is configured such that alignment of the first and the second base plates at least substantially matches alignment of the interior surface of the lower panel, the first and the second inclined walls are angled away from the interior surface and the center wall is spaced at a distance from the interior surface.

11. The overhead stowage bin assembly according to claim 1, wherein the covering is connected to the lower panel such that the covering and the inner passage formed thereby extend in a lateral direction from one side of the lower panel to an opposite side of the lower panel, and the plurality of ribs are uniformly spaced from each other along the covering in the lateral direction and extend perpendicular to the lateral direction.

12. The overhead stowage bin assembly according to claim 11, wherein each of the plurality of ribs comprises at least one ridge that protrudes from the rib and extends across the rib in the lateral direction, the at least one ridge forming a contact surface for abutting the objects within the interior of the stowage bin assembly.

13. The overhead stowage bin assembly according to claim 11, wherein the plurality of ribs are aligned substantially parallel to each other, and each of the plurality of ribs comprises two ridges located on a side of the rib closer to the rear of the stowage bin assembly, the two ridges protrude from the rib and extend at least substantially perpendicular to the rib, the two ridges forming contact surfaces for abutting the objects stowed within the interior of the stowage bin assembly.

14. The overhead stowage bin assembly according to claim 5, wherein the threshold is an aluminum extrusion.
